(19) United States
(12) Patent Application Publication
(10) Pub. No.: US 2015/0060447 A1
(43) Pub. Date: Mar. 5, 2015

(54) Buoyant Liquid Cover Members

(71) Applicant: Matt Alirol, The Dalles, OR (US)

(72) Inventor: Matt Alirol, The Dalles, OR (US)

(21) Appl. No.: 14/012,735

(22) Filed: Aug. 28, 2013

(51) Int. Cl. B65D 88/36; B29C 49/00; B29C 45/00; B29C 67/00

(52) U.S. Cl. CPC B65D 88/36; B29C 67/0051; B29C 49/00; B29C 45/00; B29L 2031/706
USPC 220/218; 264/523; 264/299; 264/308

(57) ABSTRACT

Systems and methods for covering the surface of a body of liquid, including a plurality of buoyant members, each having the shape of a rhombic dodecahedron including twelve identical quadrilateral faces, configured to float on the surface of the body of liquid and to substantially cover the surface of the body of liquid. The plurality of buoyant members naturally align when floating on the surface of the body of liquid with a quadrilateral face of a rhombic dodecahedron abutting a quadrilateral face of an adjacent rhombic dodecahedron and the plurality of buoyant members form a closely packed floating arrangement of face-to-face abutting rhombic dodecahedrons that substantially covers the surface of the body of liquid.

### BACKGROUND

The present disclosure relates generally to buoyant liquid cover members, systems, and methods for covering the surface of a body of liquid. In particular, buoyant members having a quadrilateral rhombic dodecahedron shape that allow the members to automatically abut face-to-face and float on a liquid surface with part of the volume of the dodecahedron being under the liquid surface.

Ponds, reservoirs, and open tanks are often used to store and treat liquids. Liquids having large open surfaces are common in the fields of chemical production, anodizing, galvanizing, plating, dying, sewage treatment, oil waste storage, and other such fields. In many of these fields, unimpeded access to the liquid is desired. However, having large open liquid surfaces may lead to evaporation of the stored liquid and emission of noxious fumes.

Reducing fluid loss, toxic vapors emission, and heat loss is a major environmental and financial concern. The reduction of evaporation and heat transfer is influenced by a variety of factors, such as wind conditions above the liquid surface, liquid temperature, environment temperature, liquid density, and the concentration of the substance evaporating in the air. Reducing evaporation will also reduce noxious fumes.

Known liquid coverings are not entirely satisfactory for the range of applications in which they are employed. For example, existing air-filled spherical surface covers are susceptible to being blown away from the liquid surface in windy conditions. However, conventional surface covers that have heavier designs often suffer from high shipping costs.

Additionally, liquid covers in the form of spheres cannot completely blanket the total liquid surface area, precisely because of their spherical shape. By continuously revolving and exposing a freshly wetted surface, spheres allow liquid evaporation to take place. Furthermore, dust and dirt deposited on the top of the floats is passed into the liquid when they revolve.

Other existing liquid covers tend to pile up when initially fed to the reservoir rather than orienting themselves to cover the surface. Also when some covers are removed from the reservoir, the remaining covers are displaced and may leave a hole in the surface covering.

Thus, there exists a need for buoyant members, systems, and methods for covering the surface of a body of liquid that improve upon and advance the design of known liquid covering systems. Examples of new and useful buoyant members relevant to the needs existing in the field are discussed below.

Disclosure addressing one or more of the identified existing needs is provided in the detailed description below. Examples of references relevant to liquid covers include U.S. Pat. No. 3,993,214, U.S. Pat. No. 3,938,338, and U.S. Pat. No. 8,342,352. The complete disclosures of the above patents and patent applications are herein incorporated by reference for all purposes.

### SUMMARY

The present disclosure is directed to buoyant members, systems, and method for covering the surface of a body of liquid. A system for covering the surface of a body of liquid, may include a plurality of buoyant members each having the shape of a rhombic dodecahedron configured to float on the surface of the body of liquid and to substantially cover the surface of the body of liquid, each of the buoyant members including twelve quadrilateral faces. The plurality of buoyant members naturally align when floating on the surface of the body of liquid with a quadrilateral face of a rhombic dodecahedron abutting a quadrilateral face of an adjacent rhombic dodecahedron and the plurality of buoyant members forming a closely packed floating arrangement of face-to-face abutting rhombic dodecahedrons. The closely packed floating arrangement of rhombic dodecahedrons is essentially free of an edge-to-face or an edge-to-edge abutting dodecahedron arrangement.

In the foregoing embodiment, the buoyant members may include a structural foam material, for example, with a specific gravity being approximately one half the specific gravity of the liquid, or a substantially hollow structure that includes a fluid so that half or less of the volume of the buoyant member is submerged in the body of liquid when floating.

Further according to the disclosure, a buoyant member may include a body substantially shaped as a rhombic dodecahedron with twelve quadrilateral faces and the body having a density that is less than the density of the liquid. In some examples, the body may be solid, include a material of a uniform density, include a structural foam, for example with a specific gravity that is approximately one half the specific gravity of the body of liquid, or further include a hollow portion including a fluid so that half or less of the volume of the body is submerged in the body of liquid when floating.

In some embodiments, the body may be made by blow molding, by injection molding, or by 3D printing. The body of the buoyant member may include a foamed plastic, polypropylene, polystyrene, or a high density polyethylene.

The inventive subject matter further contemplates a method for covering the surface of a body of liquid, by applying a plurality of buoyant members to a body of liquid, each buoyant member having a body substantially shaped as a rhombic dodecahedron with twelve quadrilateral faces and the body having a density that is less than the density of the liquid, by allowing the plurality of buoyant members to naturally align when floating on the surface of the body of liquid with a quadrilateral face of a rhombic dodecahedron abutting a quadrilateral face of an adjacent rhombic dodecahedron, and by adding buoyant members to the body of liquid to form a closely packed floating arrangement of face-to-face abutting rhombic dodecahedrons that substantially covers the surface of the body of liquid.

### BRIEF DESCRIPTION OF THE DRAWINGS

FIG. 1 is a top view of a first example of a buoyant member having a quadrilateral rhombic dodecahedron shape.

FIG. 2-5 are different perspective views of the buoyant member of FIG. 1.

FIG. 6 is a perspective view of the buoyant member of FIG. 1 with hidden lines shown as dashed lines.

FIG. 7 is a perspective view of a system for covering the surface of a body of liquid with a closely packed arrangement of buoyant members.

FIG. 8 is a top view of the closely packed arrangement of FIG. 7 when floating in a body of liquid.

FIG. 9 is a cross-sectional view of the closely packed arrangement of FIG. 8 along line 9-9.

FIG. 10 is a top view of a second example of a buoyant member having a quadrilateral rhombic dodecahedron shape.

FIG. 11 is a top view of another example of a buoyant member having a quadrilateral rhombic dodecahedron shape.

FIG. 12 is an enlarged, top plan view of a portion of a liquid cover, as known in the art.

FIG. 13 is a cross-sectional view along line 13-13 in FIG. 12 of a portion of the liquid cover known in the art.

FIG. 14 is a cross-sectional view along line 14-14 in FIG. 13 of a portion of the liquid cover known in the art.

### DETAILED DESCRIPTION

The disclosed buoyant members, systems, and methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various buoyant members, systems, and methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The inventive subject matter is generally directed to a buoyant member with a geometry that allows faces of two separate polyhedrons to naturally abut face-to-face. When placed in a body of liquid, the buoyant member floats on the surface of the body of liquid and substantially reduces exposure to sunlight, evaporation, and heat loss from an open liquid surface, such as areas of water, waste water bodies, industrial and chemical ponds, petrochemical ponds, general processing industry water tanks and ponds, by arranging themselves to substantially cover the surface of the body of liquid. The buoyant members automatically align in a packed arrangement while floating on the surface and generally do not impede movement of the liquid at the surface of the body of liquid.

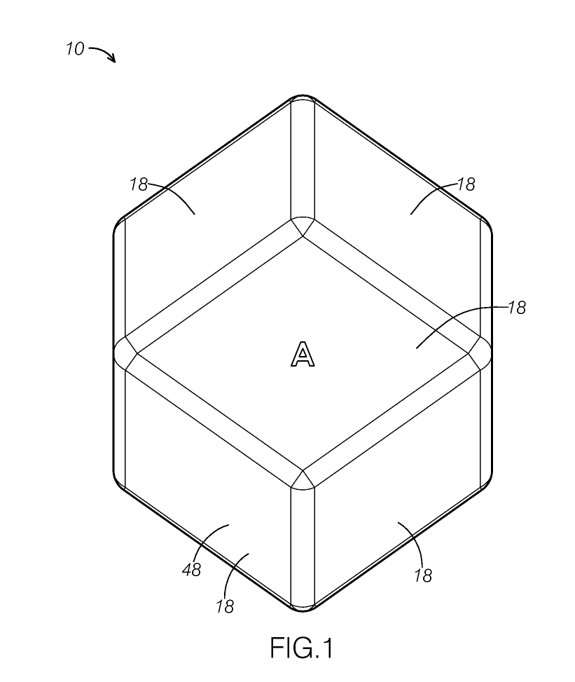

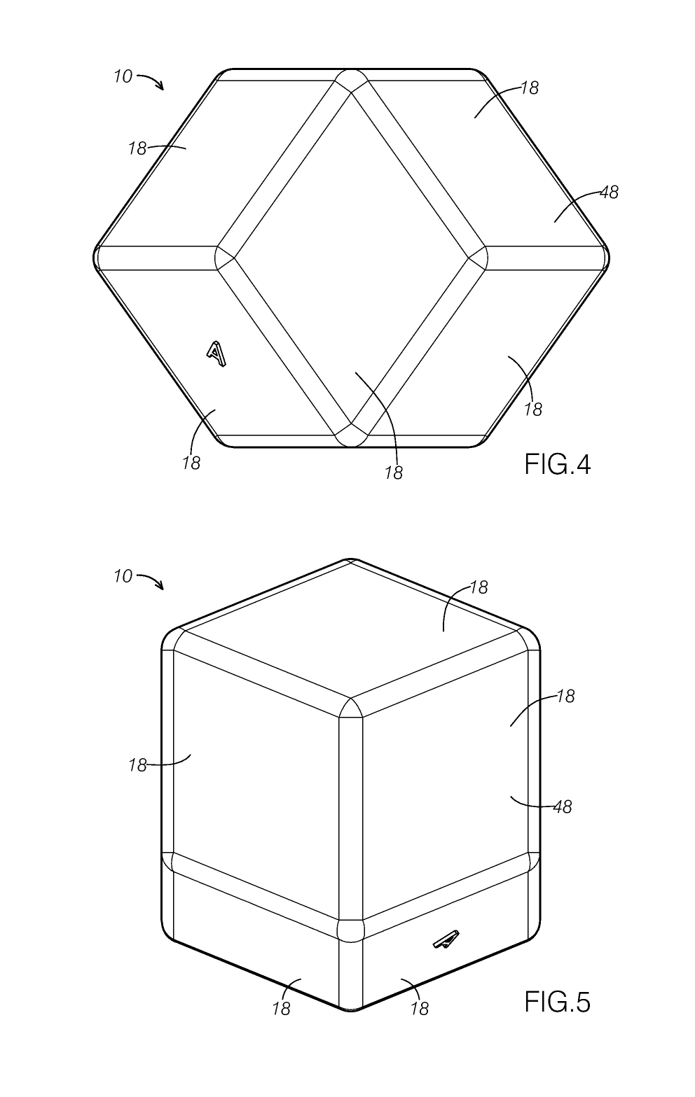

With reference to FIGS. 1-6, a first example of a buoyant member, will now be described. Buoyant member 10 has a substantially quadrilateral rhombic dodecahedron shape. As used herein, the term “quadrilateral rhombic dodecahedron” refers to a polyhedron with 12 faces that are substantially identical, 14 vertices, and 24 edges (dodecahedron), each face has four sides (quadrilateral), and opposite sides of each face are parallel to each other (rhombic).

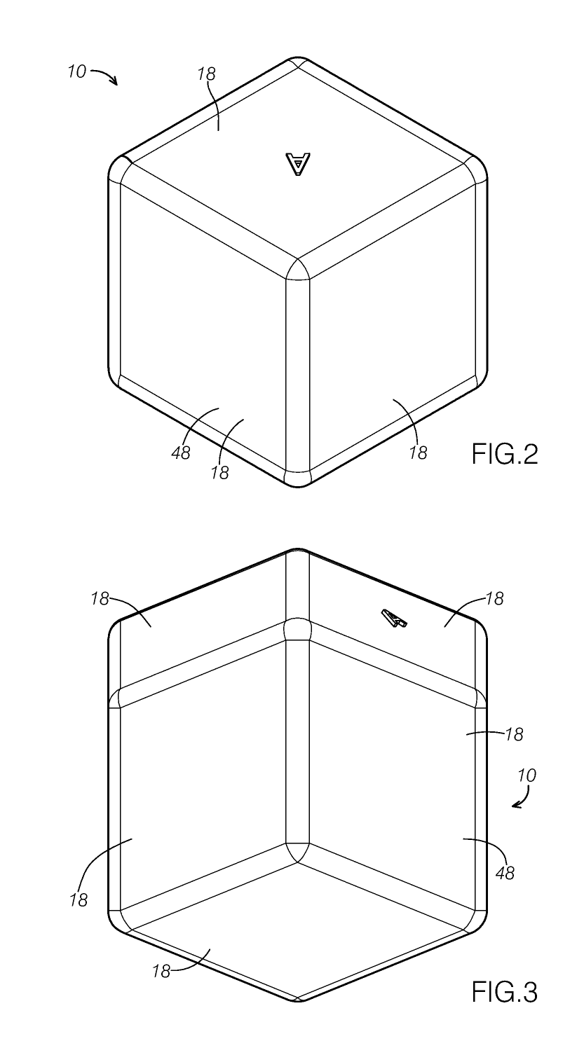

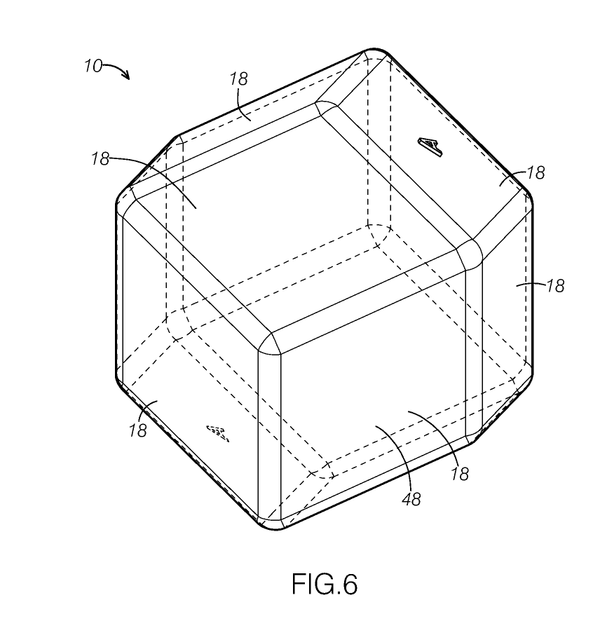

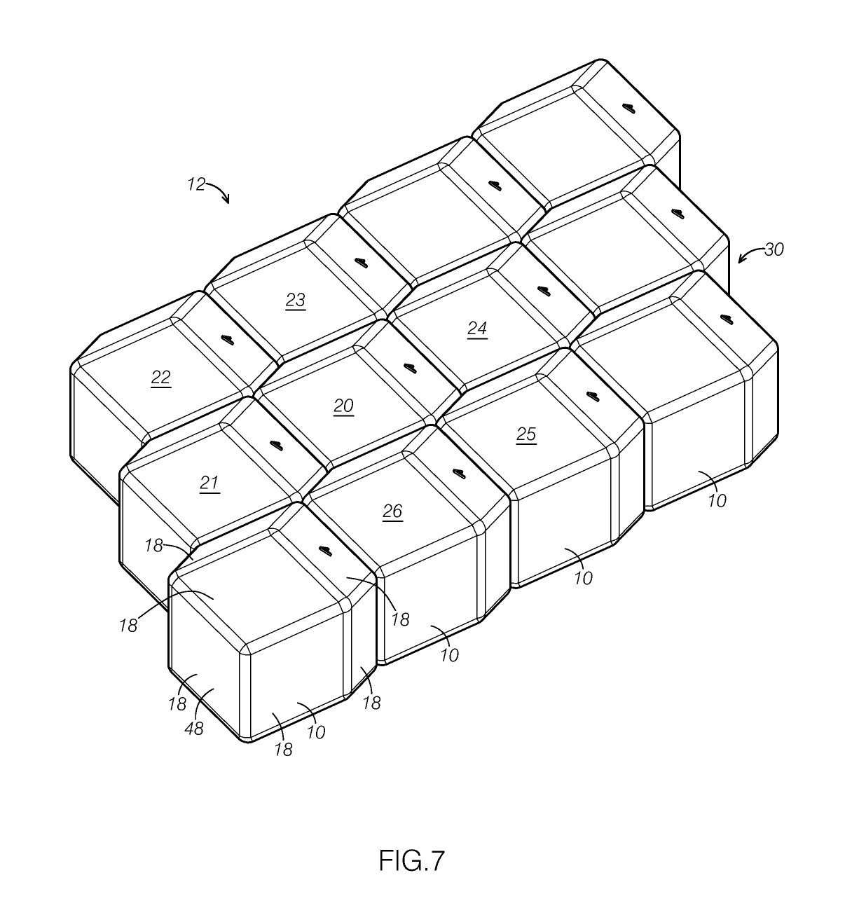

As can be seen in FIGS. 1-6, buoyant member 10 includes a body 48 having a 12 substantially identical quadrilateral faces 18. FIGS. 2-5 show buoyant member 10 at different angles. For example, for clarity, side A of buoyant member 10 has been marked with the letter “A” and can be seen in FIGS. 1-5 from different perspectives. FIG. 6 shows another view of buoyant member 10 with hidden lines shown as dashed lines.

Buoyant member 10 has a density or structure designed to float on the surface of a body of liquid. For example, in some embodiments the buoyant member may be made of a substantially hollow shell. In further embodiments, the buoyant member may be partially or entirely filled with a fluid, whether a liquid or a gas, or with foam to impart the desired floating effect.

In other embodiments, the buoyant member may be made of a substantially solid or uniform structure made of a material with a desired density and/or buoyancy. Suitable materials for buoyant members comprised of a uniform material as opposed to a shell and cavity configuration include structural foams. Suitable structural foams include polystyrene foams. Injection molding is an effective technique for making buoyant members from uniform materials, such as structural foams.

Examples of suitable materials for the shell portion of a shell and cavity configuration buoyant member include high density polyethylene, polypropylene, or polystyrene. The cavity may be filled with any material or combination of materials to impart a desired buoyancy to the buoyant member, including water, air, nitrogen, oils, polystyrene foams, and the like. Blow molding techniques may be used to form the shell of the buoyancy member and then the shell may be filled, fully or partially, with a desired material.

Optionally, buoyant member 10 may be formed of a material resistant to corrosive solutions. In some embodiments, buoyant member 10 may be formed of a material which can withstand high liquid and/or environment temperatures.

Further example embodiments may include buoyant members made of any material with desired chemical, thermal, or mechanical properties. In some embodiments, composites of materials may be used to vary densities in the buoyant member, properties of the buoyant member, or to reduce manufacturing and/or transportation costs. In some other example embodiments, the buoyant member may have a coating, for example to reflect light or absorb heat.

In some embodiments, the buoyant member rests on the surface of the body of liquid with the surface being substantially on the equator of the dodecahedron, i.e., with about half of the volume of the buoyant member above the surface of the body of liquid and about half of the volume of the buoyant member below the surface of the body of liquid.

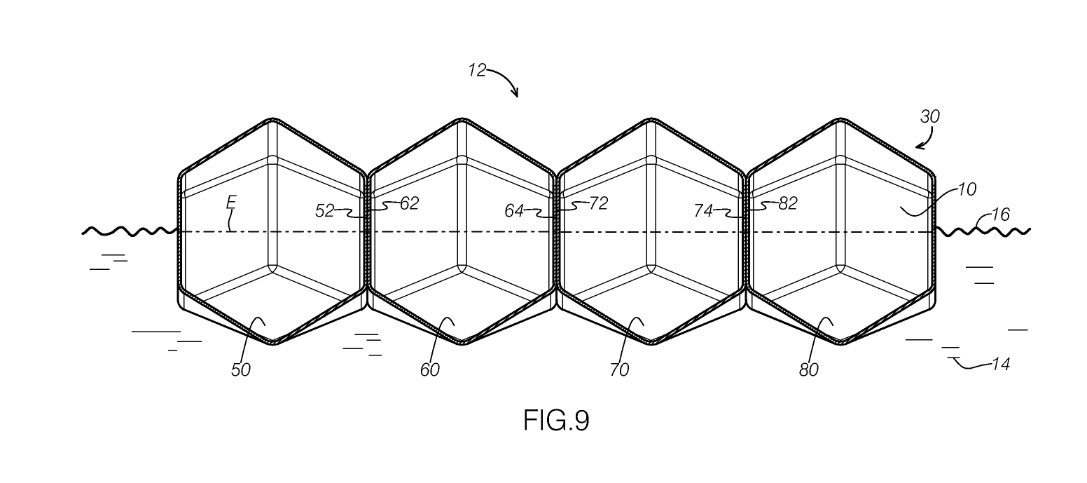

FIGS. 7-9 shows a system 12 including an arrangement 30 of buoyant members 10. In particular, as shown in FIG. 9, buoyant members 50, 60, 70, and 80, are floating on a body of liquid 14 with the surface 16 of body of liquid 14 being approximately at the equator E of the buoyant members 50, 60, 70, and 80. In other embodiments, a buoyant member 10 may have a floating resting state wherein the surface of the body of liquid is above or below the equator of the dodecahedron. For example, buoyant members may be anywhere from 10% to 60% submerged when deployed on a liquid body, depending on the application.

When a sufficient number of buoyant members is placed into a body of liquid, the buoyant members disperse themselves over the surface. According to the disclosed system, buoyant members automatically align in a packed arrangement of buoyant members that includes face-to-face oriented quadrilateral rhombic dodecahedrons floating on the surface of the body of liquid. The buoyant members arrange themselves side-by-side to substantially cover the surface of the liquid body without requiring additional action to the surface or the system.

The number of buoyant members required to substantially cover the surface of the body of liquid depends on the application, for example the size of the buoyant members and the surface area of the body of liquid to be covered. In some embodiments, buoyant members may measure about 6 inches by about 6 inches by about 6 inches. Of course, the buoyant members may be any dimension suitable for a given application, including approximately 1-6 inches in each dimension, 7-11 inches in each dimension, or 12 or more inches in each dimension.

Generally, the buoyant members in the system will all have the same dimensions. However, in some applications, the dimensions of the buoyant members in the system are different from each other. It is understood, however, that a buoyant member or collection of buoyant members may have any dimensions suitable for a particular application.

In some applications, dozens, hundreds, or even thousands of buoyant members may be used to substantially cover the surface of a reservoir depending on the size of the reservoir.

The inventive subject matter further contemplates a method for covering the surface of a body of liquid. According to an example embodiment, a plurality of buoyant members are applied to a body of liquid, each buoyant member having a body substantially shaped as a rhombic dodecahedron with twelve quadrilateral faces and the body having a density that is less than the density of the liquid. The plurality of buoyant members are allowed to naturally align when floating on the surface of the body of liquid with a quadrilateral face of a rhombic dodecahedron abutting a quadrilateral face of an adjacent rhombic dodecahedron. Buoyant members are added to the body of liquid to form a closely packed floating arrangement of face-to-face abutting rhombic dodecahedrons that substantially covers the surface of the body of liquid. In some embodiments, part of the volume of the buoyant member is under the surface of the body of liquid.

FIG. 7 shows a system 12 for covering the surface of a body of liquid including an arrangement 30 of closely packed buoyant members 10 wherein each buoyant member 10 is oriented with at least one face of the buoyant member abutting a face of an adjacent buoyant member. Some buoyant members may have more than one face of the dodecahedron aligned with a face of an adjacent dodecahedron. For example, FIG. 7 shows a buoyant member 20 having six sides (quadrilateral faces) face-to-face aligned with faces of adjacent buoyant members, in particular buoyant members 21, 22, 23, 24, 25, and 26.

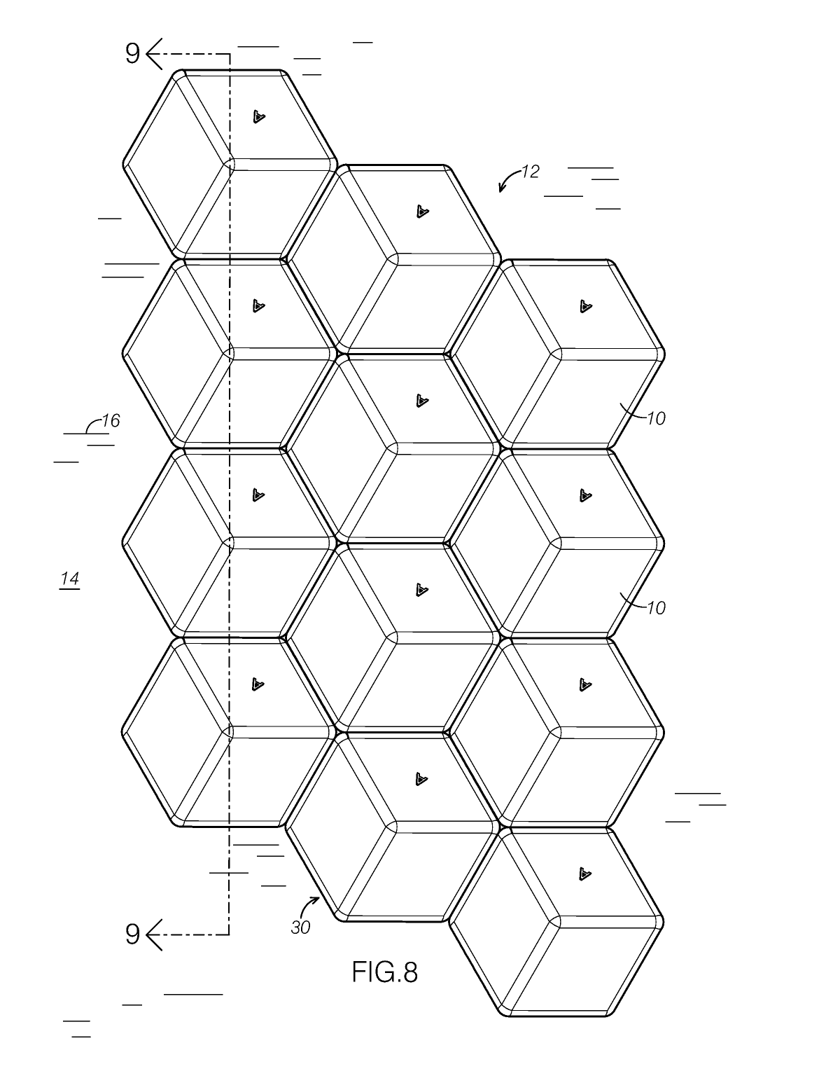

FIGS. 8-9 show a portion of a single layer arrangement of closely packed buoyant members 10 in a body of liquid 14, for example as they may be arranged in an open process tank or a reservoir. Buoyant members 10 are positioned side-by-side, for example buoyant members 50, 60, 70, and 80 are aligned with quadrilateral faces facing each other. In particular, each dodecahedral shape has faces that each abut a face of an adjacent dodecahedral shape. For example, buoyant member 50 with quadrilateral face 52 abuts quadrilateral face 62 of buoyant member 60, quadrilateral face 64 of buoyant member 60 abuts quadrilateral face 72 of buoyant member 70, and quadrilateral face 74 of buoyant member 70 abuts quadrilateral face 82 of buoyant member 80. The pattern may be repeated on all sides of the buoyant member, if needed, to cover the desired portion of surface 16 of body of liquid 14.

It is understood, however, that to substantially cover a surface of a body of liquid, or a portion thereof, the arrangement is repeated so that essentially all of the open surface of the body of liquid is covered by buoyant members and practically no surface of the body of liquid is exposed to open air.

In some embodiments, a system may include multiple layers of buoyant members packed on top of each other. For example, a system may include an arrangement similar to the one shown in FIG. 9 and may have another arrangement of closely packed buoyant members superimposed on top of the arrangement 30 such that free faces of the first layer of dodecahedrons abut free faces of the second layer of dodecahedrons. If a second layer of dodecahedrons is superimposed on a first layer, the dodecahedrons tend to automatically align or stack in a packed arrangement. In other embodiments, multiple layers of closely packed arrangements may be stacked on top of each other.

When the surface of a body of liquid is disturbed, for example when turbulence, agitation, or vibration occurs on the surface of the body of liquid, the quadrilateral rhombic dodecahedron shape allows the buoyant members to automatically re-align. Faces of adjacent buoyant members may separate when the buoyant members float apart but the buoyant members tend to automatically return in a face-to-face abutting arrangement.

The face-to-face abutment realized by the buoyant members is more stable and effective than a thin edge-to-edge abutment or a face-to-edge abutment as is, for example, present in a pentagonal dodecahedron structure, such as described in U.S. Pat. No. 3,993,214. A pentagonal dodecahedron structure having five-sided faces results in edge-to-edge abutment in at least one coordinate direction.

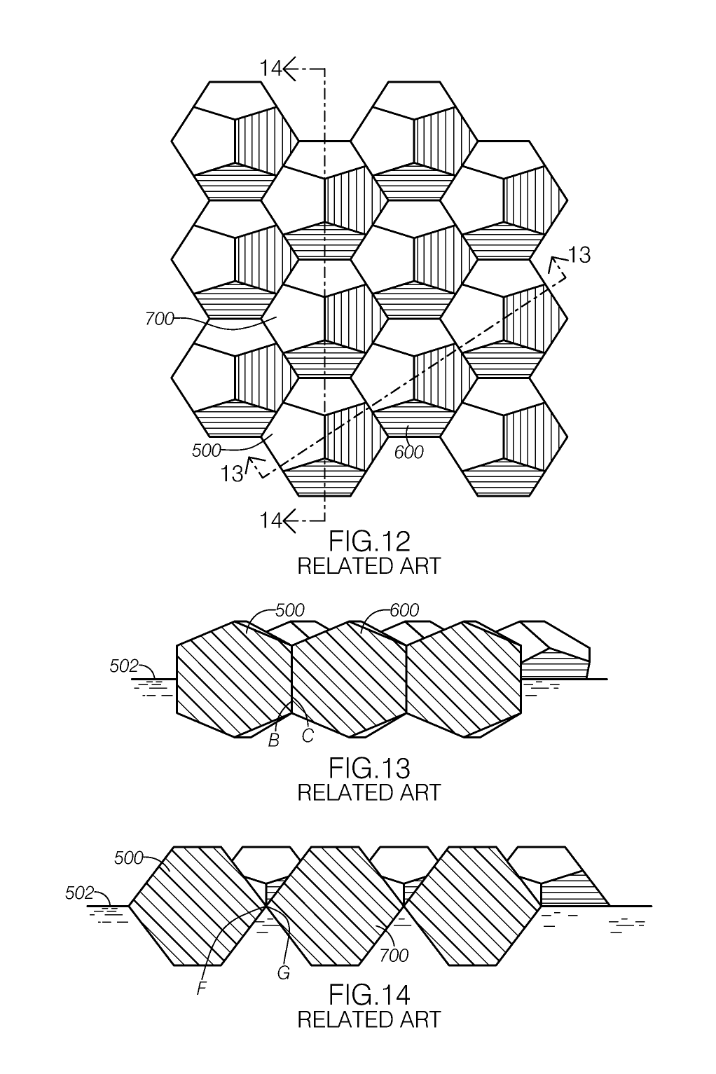

FIGS. 12-14 show portions of a liquid cover formed of a number of pentagonal dodecahedrons that are aligned on close proximity, as known in the art. FIG. 12 shows a side-by-side alignment in a first coordinate direction wherein the pentagonal faces of one dodecahedron, for example, pentagonal face B of pentagonal dodecahedron 500, are abutting pentagonal faces of an adjacent dodecahedron for example, pentagonal face C of pentagonal dodecahedron 600 when floating on a liquid surface 502. FIG. 13 shows a side-by-side alignment in a second coordinate direction wherein adjacent dodecahedrons abut edge-to-edge, for example, edge F of pentagonal dodecahedron 500 abuts edge G of pentagonal dodecahedron 700.

In contrast, buoyant members according to the current disclosure align face-to-face in all coordinate directions. Buoyant members in such a face-to-face alignment are closely packed and tend to remain in the same configuration, without tendency to rotate, resulting in effective sealing of the surface. Additionally, in case the buoyant members are turned in any direction, for example in windy conditions, they are capable of substantially the same functionality, i.e., a buoyant member may be flipped but will tend to realign in a face-to-face arrangement.

In some embodiments, buoyant member 10 includes a material having a specific gravity that is about half of the specific gravity of the liquid in the reservoir. For example, buoyant member 10 may include a foam material having a specific gravity that is approximately one half the specific gravity of the surrounding liquid. With such a specific gravity, the buoyant member will float on the surface of the body of liquid with the liquid surface approximately on the equator of the dodecahedron. Such buoyant members tend to rest with the fluid surface approximately on the equator of the dodecahedron, even in turbulent circumstances.

In some example embodiments, a buoyant member may be made of a hollow shell. For example, a buoyant member may be made of a shell formed of a polyethylene and air or another fluid trapped inside the shell. Other embodiments may include a buoyant member formed of a structure having an external quadrilateral rhombic dodecahedron shape in combination with features on the inside of the dodecahedron structure that assist in achieving the desired buoyancy of the buoyant member.

In some embodiments, the interior of a buoyant member may have a cavity, for example a chamber positioned substantially in the center of the buoyant member. Some buoyant members may receive different amounts of liquid into such a cavity. Other embodiments may have differently sized recessed areas or open ended cavities.

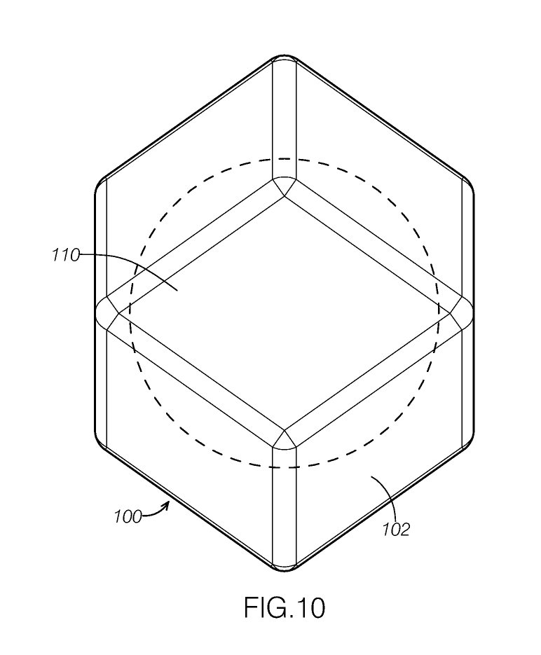

In the example shown in FIG. 10, a buoyant member 100 has a body 102 including a chamber 110. Buoyant member 100 includes many similar or identical features as buoyant member 10, described above. Thus, for the sake of brevity, each feature of buoyant member 100 will not be redundantly explained. Rather, key distinctions between buoyant member 100 and buoyant member 10 will be described in detail and the reader should reference the discussion above for features substantially similar between the two buoyant members.

The chamber may define a cylinder, sphere, or any other shape, for example made of an air and water tight material. The dimensions of the chamber may vary and correlate with the dimensions of the surrounding dodecahedron shape. The chamber may enclose a predetermined amount of a gas, such that when a buoyant member is placed in water, the buoyant force of the substance enclosed in the chamber combined with any buoyant force created by the density of the member's construction material is sufficient to keep the member afloat on the body of liquid. The submerged portion of the buoyant member's exterior surface is at a predetermined depth below the surface of the body of liquid.

In some embodiments, a quantity of liquid from the body of liquid may be introduced into the buoyant member's cavity, for example through a permeable wall or an opening, and is used to apply an additional downward force to the buoyant member. To increase the buoyancy, a greater volume of gas may be enclosed in the chamber. To decrease the buoyancy, the volume of gas enclosed in the chamber may be decreased.

By adjusting the substance contained within the chamber, buoyancy of a buoyant member may be adjusted. By adjusting both the buoyant force created by the substance in the chamber and the quantity of liquid that is introduced into the cavity, buoyant members may be designed to float at different depths. For example, the substance contained within the chamber may be air or any gas. In other embodiments, foams or other materials that are generally understood to include air pockets may also be placed inside the chamber. In further embodiments, a water absorbing material may be included in a chamber that is in connection with the body of liquid.

In some examples, a buoyant solid material may be added to the chamber, or a substance with relatively high density may be added to stabilize the member while positioned in a liquid body.

In some examples, it may be desirable to adjust the amount of liquid within the cavity of the buoyant member, for example when adjusting the member's wind resistance. Such modifications may be useful in adapting buoyant members for use in liquids of varying densities.

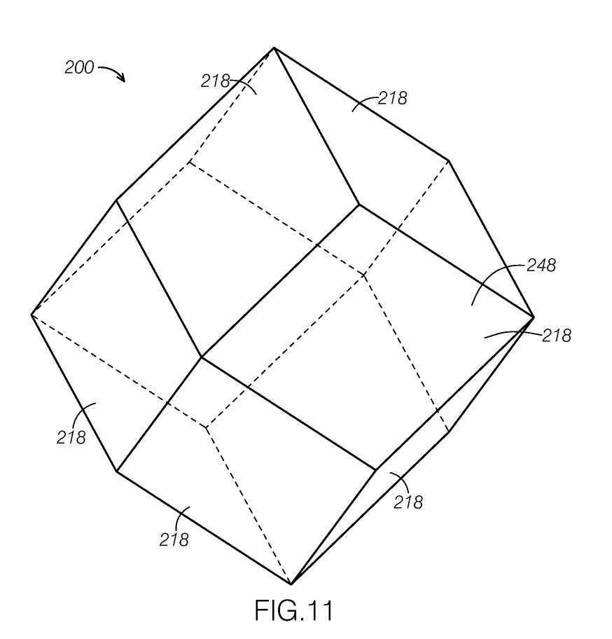

FIG. 11 illustrates another example of buoyant member 200 having a quadrilateral rhombic dodecahedron shape. Buoyant member 200 includes a body 248 having 12 substantially identical quadrilateral faces 218. Whereas FIGS. 1-10, show buoyant members 10 and 100 having slightly rounded edges, FIG. 11 illustrates an example of a quadrilateral rhombic dodecahedron body 248 having sharper edges.

According to the disclosure, buoyant members may be made by any suitable manufacturing techniques, including, for example, injection molding, blow molding, or 3D printing techniques.

In some embodiments, the buoyant member may be made by injection molding, for example as a solid structure. In other example embodiments, a buoyant member may be made of two parts that are joined via a welded union that is water and air tight. For example, molded halves of a high-density polyethylene may be fused together using a hot plate to form a buoyant member. Other techniques, such as ultrasonic welding, high frequency welding, friction welding, spin welding, laser welding, hot gas welding, free-hand welding, and the like can also be used to join parts.

Further embodiments of buoyant members may be constructed by blow molding techniques. Using a blow molding technique, may be desirable where high speed fabrication is required. For example, a buoyant member can be fabricated in one simple operation, removing the need for welding two halves. In some examples, ports may be drilled into the sidewalls of the member after it is formed by blow molding.

In some embodiments, liquid or foam may be added internally to the buoyant member by the manufacturer before the buoyant members are shipped to the end user, for example as a ballast or an insulation material. In further embodiments, buoyant members may be made of a liquid permeable material or naturally fill with liquid from the reservoir through holes in the cover unit when added to the reservoir, for example, a buoyant member may have two or more openings on opposite sides of the member along the equator of the dodecahedron.

In some embodiments, buoyant members may be made entirely or partially out of an ultraviolet stabilized high density polyethylene. For example, the use of ultraviolet stabilized high density polyethylene may help the buoyant member maintaining its integrity during outdoor use over an extended period of time. According to one example, adding carbon black to a polyethylene material, at a ratio of 2%, may provide protection against ultraviolet light degradation of the polyethylene material. In other embodiments, different ratios of added carbon black may be desired. For example, ultraviolet light protection or stabilization may be achieved by adding carbon black to the material, such as a high density polyethylene or a polypropylene, in a ratio of approximately 2% to approximately 10%.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

The invention claimed is:

1. A system for covering the surface of a body of liquid, comprising:
a plurality of buoyant members each having the shape of a rhombic dodecahedron configured to float on the surface of the body of liquid and to substantially cover the surface of the body of liquid, each of the buoyant members including twelve quadrilateral faces; and
wherein the plurality of buoyant members naturally align when floating on the surface of the body of liquid with a quadrilateral face of a rhombic dodecahedron abutting a quadrilateral face of an adjacent rhombic dodecahedron and the plurality of buoyant members forming a closely packed floating arrangement of face-to-face abutting rhombic dodecahedrons.

2. The system of claim 1, wherein the closely packed floating arrangement of rhombic dodecahedrons is essentially free of an edge-to-face or an edge-to-edge abutting dodecahedron arrangement.

3. The system of claim 1, wherein the plurality of buoyant members includes a structural foam material.

4. The system of claim 3, wherein the specific gravity of the structural foam material is approximately one half the specific gravity of the liquid.

5. The system of claim 1, wherein the plurality of buoyant members include a rhombic dodecahedron that is substantially hollow and that comprises a fluid so that half or less of the volume of the buoyant member is submerged in the body of liquid when floating.

6. A buoyant member for floating on the surface of a body of liquid , comprising:
a body substantially shaped as a rhombic dodecahedron with twelve quadrilateral faces and the body having a density that is less than the density of the liquid.

7. The buoyant member of claim 6, wherein the body is solid.

8. The buoyant member of claim 6, wherein the body includes a material of a uniform density.

9. The buoyant member of claim 6, wherein the body includes a structural foam.

10. The buoyant member of claim 9, wherein the structural foam has a specific gravity that is approximately one half the specific gravity of the body of liquid.

11. The buoyant member of claim 6, further comprising a hollow portion including a fluid so that half or less of the volume of the body is submerged in the body of liquid when floating.

12. The buoyant member of claim 6, wherein the body is made by blow molding.

13. The buoyant member of claim 6, wherein the body is made by injection molding.

14. The buoyant member of claim 6, wherein the body is made by 3D printing.

15. The buoyant member of claim 6, wherein the body comprises a foamed plastic.

16. The buoyant member of claim 6, wherein the body comprises a polypropylene.

17. The buoyant member of claim 6, wherein the body comprises a high density polyethylene.

18. A method for covering the surface of a body of liquid, comprising:
applying a plurality of buoyant members to a body of liquid, each buoyant member having a body substantially shaped as a rhombic dodecahedron with twelve quadrilateral faces and the body having a density that is less than the density of the liquid;
allowing the plurality of buoyant members to naturally align when floating on the surface of the body of liquid with a quadrilateral face of a rhombic dodecahedron abutting a quadrilateral face of an adjacent rhombic dodecahedron; and
adding buoyant members to the body of liquid to form a closely packed floating arrangement of face-to-face abutting rhombic dodecahedrons that substantially cover the surface of the body of liquid.

19. The method of claim 18, wherein the buoyant member comprises a high density polyethylene.

20. The method of claim 18, wherein part of the volume of the buoyant member is under the surface of the body of liquid.
